(19) United States
(12) Patent Application Publication
(10) Pub. No.: US 2011/0208973 A1
(43) Pub. Date: Aug. 25, 2011

(54) OVERALL OPTIMIZATION OF THE CONFIGURATION OF A MESHED WIRELESS NETWORK OF RF DEVICES IN AN AIRCRAFT

(75) Inventors: Charlotte Jimenez, Aix En Provence (FR); Stéphane Dauzere-Peres, Gardanne (FR)

(73) Assignee: EUROCOPTER, Marignane (FR)

(21) Appl. No.: 13/028,665

(22) Filed: Feb. 16, 2011

(30) Foreign Application Priority Data
Feb. 23, 2010 (FR) 10 00734

(51) Int. Cl. G06G 7/62; G06F 17/10; H04L 9/32

(52) U.S. Cl. 713/181; 703/2; 703/13

(57) ABSTRACT

The invention relates to overall optimization of an identification system (2) comprising a meshed wireless network of RF devices (17) on board an aircraft (1). Starting from an inventory (51) of components of the aircraft (1) that need to be identified, a list (50) is drawn up of “modeling” input parameters (34-39) and a series (27) is drawn up of functional constraints. A plurality of potential profiles (V1, Vn) is modeled for identification systems (2). Said plurality of potential profiles (V1-Vn) is sorted in order to define a restricted group (32) of acceptable versions, and then a target function (47) using automatic comparison (33) of multiple cases is applied to determine an eligible version (Vx) that is optimized, having decision and state variables (45, 46) with values that are of binary order for the aircraft (1) as a whole.

### CROSS REFERENCE TO RELATED APPLICATION

The present application claims the benefit of French patent application FR1000734 filed on Feb. 23, 2010, the disclosure of which is incorporated herein by reference.

### BACKGROUND OF THE INVENTION

1. Technical Field

The invention seeks to optimize the configuration of a meshed wireless network of radiofrequency (RF) devices. Some of these devices are coupled to components on board an aircraft, in order to mark the components. These marking RF devices are in the form of electronic labels. They are referred to as marking or coupled RF devices.

2. Description Of The Related Art

Such marking serves to record traceability information in an RF device that is paired with a component on board the aircraft. This record comprises initial recording of traceability information, together with updates and modifications, in particular.

One form of marking by means of RF devices is already known in airliners. That marking is used solely to provide traceability for accessories such as life jackets and oxygen cylinders.

In order to contribute to the configuration, maintenance, and logistics of an aircraft, the marking to which the invention applies provides traceability not of accessories such as life jackets, but rather of on-board components forming part of the aircraft. The term “on-board component” is used herein to mean certain components forming parts of the aircraft that are necessary for its operation or its mission. These may be pieces of vital equipment.

Document US2008180227 describes a method of modeling and optimizing the movements of a set of mobile RF units, with two access points that are compatible with those units. That document applies typically to mobile units in a logistics system having conveyors, readers, and access points that need to co-operate with said mobile units when they are near-by. That method makes use in particular of an analysis of radio frequency identification (RFID) connection conditions including mutual location angles between two contiguous mobile units. Its purpose is to avoid shadow zones that are not covered by the radio frequency (RF) coverage.

Document EP2104060 or FR2928761 describes a typical application of the invention, providing configuration tracking of an aircraft made up of a multitude of marked on-board components, where it is desired to be able to consult and to record various kinds of data specific thereto (traceability information).

To begin with, provision is made to install a plurality of RF devices on on-board components of the aircraft. The term “RF device” is used to designate all of the components of the meshed wireless network, including not only the electronic labels, but also local readers together with one or more routers or concentrators. Those RF devices are arranged to form a meshed wireless communications network that defines a secrecy perimeter.

Although it is possible in theory to mark aircraft components by means of RF devices, various technical problems put practical limits on that technique for numerous applications, such as tracking for maintenance.

At present, no method is available that is practical, simple, and realistic (reliable) for evaluating in advance an optimized scheme for marking on-board components by means of RF devices. To do this, the invention sets out to focus on certain parameters: they are referred to as “decision factors”.

By way of example, these decision factors may be the coverage of a given RF device (i.e. the possibility or impossibility of reading and/or writing at a given distance), or indeed the weight, the technology, and the cost, whether on a unit basis for a given device or on a total basis in the form of an overall estimate for an on-board configuration-tracking system.

On these lines, document U.S. Pat. No. 7,516,057 describes, in the context of marking transport pallets or boxes, a method of optimizing design structural characteristics and of implementing electronic labels (RFIDs), without incorporated storage batteries. That document provides for a unitary selection of unitary design parameters for each electronic label, as a function of an RFID reader. For given label cost, a data transfer rate is calculated by varying the modulation period of an interrogation signal generated by the reader, and also by varying the capacitance of the antenna of the label.

Mention is also made of document US2009243895, which describes collecting measurements from sensors that are regularly distributed within an airliner and that are connected as a network. Each sensor is connected by a wireless router so as to transfer its measurements via transmitters to an on-board data processor unit. The transmitters make use of the transparent or opaque properties of surrounding structures in the airliner in order to transfer measurements.

Mention is also made of the document “A heuristic approach for antenna positioning in cellular networks”, published in “Journal of Heuristics” (ISSN1381-1231), Vol. 7, No. 5, September 2001 (pp. 443-472). That document proposes a heuristic approach for finding positioning sites and antenna frequencies for a cellular telephone network from within a group of predefined candidate sites. The number and type of antennas for each site is decided in three stages: firstly filtering as a function of constraints to eliminate antennas that are unacceptable, then optimizing by the method of taboos, and finally post-optimizing in order to improve the solutions found by the method of taboos.

Furthermore, in the field of the invention, it is often necessary to be able to increase communication security, in particular in terms of authentication, but without excessively complicating or burdening the identification system.

For this purpose, an example of available technology is described in document EP2073433 or FR2925246 where making ultra high frequency (UHF) RF transactions secure implies an RF device (transponder) provided solely with a passive component having a memory zone that is freely readable. A procedure for authenticating the RF device is followed by a procedure for decrypting the payload data, which procedures are performed remotely via a reader that is likewise on board. The remote authentication procedure has recourse to an authentication digest in the form of a message authentication code obtained by hashing the payload data as a function of a secret authentication key. The remote deciphering procedure uses a generated value as well as a secret deciphering key of truncated length.

From the above, it appears that the context of the invention is incorporating RF devices in aircraft with a complex on-board transceiver system, and one of its objects is to be able to identify and to collect in a global approach, specific configurations for each aircraft fitted with such a system.

It is known that the configuration of an aircraft, in particular a rotary wing aircraft, varies enormously as a function of the type of mission. That is why “real time” information about an aircraft's configuration at a given instant would serve to increase the reliability and the accuracy of the data.

Nevertheless, identification by means of the invention has been developed to be adapted to aviation requirements. These requirements are particularly restricting. An object of the invention is to be able to read and update each marking RF device in a difficult environment (e.g. made of metal, subjected to various temperatures and to vibration) as constituted by an aircraft. By means of the invention, RF tracking should also make it possible to improve numerous industrial processes and operations in the field of aviation. This applies to maintenance contractors, and also covers production and operating conditions.

When an aircraft is in operation, regular inspection and maintenance action is required. Because of the traceability made possible by the invention, it is possible to shorten the length of time an aircraft is unavailable for flight and to give assistance to the people acting on it (user, operator, manufacturer) to perform their various tasks: making information available on line, reducing human error, tracking and providing a history of maintenance actions, etc.

For example, the invention may be useful during maintenance operations in specialist centers, in maintenance workshops, or in maintenance repair overhaul (MRO) centers, by taking advantage of the features of RF identification. The RF devices make it possible to track maintenance information: for example it is possible to track the service life limit (SLL) and the time between overhauls (TBO) of an on-board component. This makes it possible to give assistance to people performing maintenance. This information makes it possible to improve maintenance planning, and to perform and to track operations in real time.

Consequently, knowledge about the configuration of the aircraft in real time is one of the advantages that is provided by the invention. For this purpose, RF identification that is as exhaustive as possible (referred to as “overall”) must be incorporated in the aircraft.

In the abstract, numerous possibilities can be envisaged for identification in an aircraft. A wide variety of technologies exist for the RF devices needed for overall identification, i.e. paired devices (which may be passive, semi-passive, or active), readers or transceivers, data concentrators (also known as data concentrator units or (DCU)), and routers.

The same applies to the possible positions for such RF devices within the aircraft.

Furthermore, it can be understood that the various criteria, such as which technology to choose, have an influence on the configuration as a whole: for example it is possible that the greater the number of active type coupled RF devices, the smaller the number of on-board components that can be marked for some given maximum weight allocated to the intended identification system.

Unitary approaches for determining structural characteristics, as described in document U.S. Pat. No. 7,516,057, or approaches that focus only on the number or the type of antennas in a network as in document ISSN1381-1231, are respectively unsuitable and incomplete in the context of the invention.

### SUMMARY OF THE INVENTION

In order to define an ideal identification for a given aircraft configuration, the invention makes provision for comparing different available choices by optimization simulation or modeling.

In particular, the present invention addresses the complex problem of optimizing the positioning of RF devices, including the transceivers and the data concentrators and the marking devices. The invention also addresses the choice to be made amongst the various technologies available for each RF device, with respect to a given aircraft configuration.

One of the difficulties overcome by the invention is that of providing an ideal identification profile for a given aircraft configuration in spite of the fact that the input parameters and the values output by the simulation/modeling are often poorly discriminating (thus poor at making choice easy), while the various responses provided are generally rather interdependent amongst one another.

In this context, the invention proposes simulation/modeling suitable for optimizing all of the parameters for taking into consideration for identification, which method is as complete as possible for an imposed configuration for the aircraft, and while taking account of aviation constraints, in particular those concerning systems integration.

To this end, the invention is defined by the claims.

In one aspect, the invention provides a method of modeling and optimizing an RF identification system comprising a plurality of on-board components in a given aircraft configuration. The system comprises at least: two RF devices, each in the form of an electronic label coupled to an on-board component, an RF device in the form of a local reader, and an RF device in the form of a compatible wireless data concentrator and connected to said local reader; said local reader being compatible with and near at least one of said RF devices in the form of an electronic label.

In this method, starting from an inventory of on-board components that are to be identified, an input list is predefined of “modeling” parameters and a series is predefined of functional constraints that are appropriate to said given aircraft configuration; said list of modeling parameters and series of functional constraints are (transformed into) run through to model a plurality of potential profiles for identification systems, each having: a set of decision variables and a set of state variables; said set of decision variables comprising at least: a decision variable indicative of the suitability or unsuitability of a possible position for each on-board RF device; a decision variable indicative of a range of possible technologies that can be selected for each on-board RF device; and said set of state variables includes at least one variable indicative of the real radio coverage or non-coverage (i.e. coverage ability) of each RF device in the form of an electronic label at a possible position by means of its near-by reader.

Said plurality of potential profiles of identification systems is sorted as a function of said series of functional constraints to define a restricted group of acceptable versions.

Then a target function and said series of constraints are applied to automatic comparison of multiple cases in order to determine an eligible version from within the restricted group of acceptable versions by calculation to resolve said target function; said eligible version being optimized for decision and state variables having values of binary order. Said target function optimizes at least one decision factor that is determining for the selected aircraft configuration as a whole.

In an embodiment, said target function is applied by determining a “partial” eligible version for which said resolution calculation provides real values for the decision and state variables; said target function being applied again until at least one eligible version has been determined that has decision and state variables with binary values, and for which the respective decision factors are close together.

In an embodiment, an at least “partial” eligible version is determined by applying the target function and said series of constraints, when at least one election recommendation is reached by said automatic comparison of multiple cases, after which it is determined whether this partial eligible version makes it possible to provide optimized values of binary order for the decision and state variables.

For example, the election recommendation comprises at least: an error value at the optimized solution difference value derived from the target function and/or a value for the duration of processing by the automatic comparison.

One implementation provides for an adjustment of the series of functional constraints by relaxing at least one of the constraints. For example a scan is made through the series of functional constraints in order to proceed with progressive adjustment of said series, and thus accelerate determining an eligible version having binary variables.

In an embodiment, the constraint values are selected from: the effective coverage by a reader of each device in the form of a label; limiting the total number of readers for the selected configuration; restricting the total number of concentrators for the selected configuration; effective association of a choice of technology with each RF device in the form of a label; coverage between the device in the form of a label and the reader; convergence of the positions for each device in the form of a label and for its near-by reader; and boundary marker for the total weight of the identification system.

In an embodiment, in order to determine said binary values of the state variable concerning effective radio coverage of each RF device in the form of an electronic label by its near-by reader, the automatic comparison incorporates in its determination a function of a Friis equation that evaluates the powers transmitted and received by each on-board RF device.

In another aspect the invention provides an aircraft on which on-board components are identified, each with the help of at least one RF device in the form of a label, wherein the technology and the position of at least some of said devices are derived from the modeling/simulation method as mentioned above. In general, all of the RF devices of the on-board identification system are optimized using the above-specified method.

According to a characteristic, at least one RF device in the form of an electronic label is provided exclusively with a freely readable memory zone; a procedure for authenticating the RF device is followed by a procedure for deciphering payload data which procedures are performed remotely via a reader that is itself on board. The remote authentication procedure has recourse to an authentication digest in the form of a message authentication code obtained by hashing the payload data as a function of a secret authentication key. The remote deciphering procedure makes use of a generated value and of a secret deciphering key of truncated length.

### BRIEF DESCRIPTION OF THE DRAWINGS

However, other features and advantages of the invention appear from the following detailed description made with reference to the accompanying drawings.

In the drawings, FIG. 1 is a diagrammatic perspective view of an aircraft fitted with an automatic

RF identification system for tracking its configuration and derived from simulation/modeling, the system being optimized in accordance with the invention.

FIG. 2 is a diagram showing an example of an automatic tool suitable for implementing a simulation/modeling operation of the invention and including: inputs for parameters and a series of constraints; and outputs for various results, in particular in terms of values for decision variables (positioning and chosen technology “t” for all of the RF devices) and for state variables (coverage by said devices).

FIG. 3 shows an example implementation (steps/structures) of a simulation/modeling operation of the invention, from a given configuration of an identification system dedicated to a particular helicopter to a complete definition of the system in terms of values for decision and state variables.

FIG. 4 is a graph showing an example of a performance study for four identification systems (A, B, C, D) (plotted along the abscissa) that have been optimized by the invention, per type of technology for coupled RF devices (or marking labels): the continuous bold line represents passive type coupled devices; the pair of lines with long dashes represents semi-passive type coupled devices; and the pair of lines of short dashes represents active type coupled devices, and performance is evaluated (up the ordinate) in terms of distance units “L” between a coupled device and its near-by reader.

FIG. 5 is a graph similar to that of FIG. 4 showing examples of modeling the ratio between the total weight (plotted up the ordinate in units “W”) of coupled RF devices for optimizing in accordance with the invention, and two values for decision factors (CT^{t}(1) and CT^{t}(2) plotted along the abscissa in units “U”), for eight sets of circumstances defined in terms of weights and distances (i.e. of performance).

FIG. 6 is a graph showing an example of optimization by adjusting a total weight constraint value (plotted along the abscissa in weight units “W”) imposed on the identification system, relative to a decision variable (on the left variable X^{t} plotted up the ordinate in quantification units “Q”) for three types of technology selected for the marking devices, specifically: the continuous bold lines for passive type labels; the pair of lines having long dashes for semi-passive type labels; and the pair of lines having short dashes for active type labels, the variations of a decision factor (FD01 plotted up the right-hand ordinate in units “U”) being illustrated by a line of crosses (Σ).

FIG. 7 is a graph similar to that of FIG. 5 showing an example of optimizations in accordance with the invention of the ratio between the total weight (plotted up the ordinate in units W) of the on-board devices of an identification system, and two parameter values (PT^{t}(1) and PT^{t}(2)) plotted along the abscissa, for eight cost variables and for four distance performance ranges.

FIG. 8 is a graph similar to the preceding figures showing variation in the total weight (plotted up the left-hand ordinate in units W) as a function of performance (four cases A-D plotted along the abscissa) for various types of marking device technology in order to show variation for two combined decision factors.

FIG. 9 is a graph similar to that of FIG. 5 showing examples of optimization in accordance with the invention of the ratio between an overall constraint (FD01 plotted up the ordinate in units “U”) for the RF devices of an identification system relative to two parameters CT^{t}(1) and CT^{t}(2) (plotted along the abscissa) for eight cases coinciding in pairs: A1-A2; B1-B2; C1-C2; D1-D2.

FIG. 10 is a graph applicable to two predefined performance examples A and D, respectively with passive, semi-passive, and active type marking devices and relative to two parameters PT^{t}(1) and PT^{t}(2) plotted along the abscissa, showing the influence of the number of said marking devices (variable X^{t} plotted up the left-hand ordinate in quantification units “Q”).

FIG. 11 is a graph similar to that of FIG. 9 showing examples of optimization in accordance with the invention of the ratio between an overall decision factor (FD01 plotted up the left ordinate in unit “U”) for the RF devices of an identification system relative to two parameters PT^{t}(1) and PT^{t}(2) plotted along the abscissa and for eight cases A1-A2; B1-B2; C1-C2; D1-D2.

FIG. 12 is a graph showing variation in two parameters CT^{t}(1) and CT^{t}(2) relative to the performance of four types of marking device technology (four types A, B, C, and D plotted along the abscissa), and relative to the variation in the values of an overall decision factor (FD01, plotted up the left-hand ordinate in units “U”).

### DETAILED DESCRIPTION OF THE PREFERRED EMBODIMENT

In FIGS. 1 to 3, an aircraft 1, here a helicopter, is given an overall numerical reference 1. Naturally, this type of aircraft 1 is only an example. Other types of equipment subjected to similar constraints in terms of configuration tracking, such as military or civilian vehicles, e.g. road vehicles, are also covered by the invention.

The aircraft 1 possesses a considerable number of on-board components, such as for example the on-board portion of a configuration tracking system 2 that is referred to below as the identification system.

An on-board electronics arrangement of the aircraft 1 is shown diagrammatically and designated by numerical reference 3. This electronics arrangement 3 includes functional groups serving in particular to provide electrical power, and to perform radio communication and radio navigation for the aircraft 1.

The aircraft 1 includes functional sectors that often correspond to functional groups, such as for example the main rotor functional group 4 (referred to more simply as group 4), the anti-torque rotor functional group 5 (group 5), the main gearbox (MGB) functional group 6 (group 6), the tail boom functional group 7 (group 7), the turbine functional group 8 (group 8), the tanks and fluids functional group 9 (group 9), the structure and landing gear functional group 10 (group 10), and the cockpit functional group 11 (group 11).

Within the main rotor functional group 4, a blade 12 is considered as being an on-board component of the aircraft 1. Likewise, within the tail boom functional group 7, a carrier structure 13 is considered as being an on-board component of the aircraft 1. A landing skid 14 of the structure and landing gear functional group 10 is also considered as being an on-board component of the aircraft 1.

The various on-board components of the aircraft for which it is desired to provide traceability, are paired or coupled with respective RF devices 17 in the form of electronic labels referenced 17A, 17B, or 17C.

Each RF device 17A-C carries its own data 170 or traceability information. Depending on the technology used for such a marking device 17A-C, it is constituted by an electronic label of the passive, semi-passive, or active type.

In FIG. 1, the system 2 also has an installation 15 that is external to the aircraft 1, with one or more tracking tools, such as the tool given numerical reference 16.

The tracking tool 16 in this example is a computer. For example, one embodiment provides for said tool 16 to be a pocket computer.

On the aircraft 1, many of the RF devices 17 are wireless electronic labels. Each of the RF devices 17 is coupled to an on-board component (e.g.: 3, 4, 10, 12-14) of the aircraft 1, for which it is desired to provide tracking.

In FIGS. 1 to 3, certain marking devices (or transponders) are of the active type and they are referenced 17A. The RF devices 17 that are of semi-passive type are referenced 17B, whereas the RF devices that are of passive type are referenced 17C. The invention makes use of:

active devices 17A (represented by a circle with a double-line cross, or in the graphs by a pair of dashed lines) that have an internal battery enabling the chip to be powered and to broadcast a signal to a reader 18. The availability of the signal from such an RF device 17A is continuous at a range of 30 meters, for example. The strength of the signal from the RF device 17A is high, while the signal strength required by the reader 18 is very low;

passive RF devices 17C (symbolized by a circle having a cross with single-line branches, or on the graphs by a pair of lines: a continuous bottom line and a dashed top line) do not have batteries, the power supply being extracted from radio waves coming from some other device 17 (reader 18), the operation of the freely-readable memory zone thus depending on the operation of a reader 18. The availability of a passive device 17C is limited to the emission field of the reader 18 which is less than 3 meters, for example. The strength of the signal from the passive device 17C is low. Unlike an active device 17A, the signal strength required by the reader 18 for reading a passive device 17C is very high; and

semi-active RF devices 17B (symbolized by a circle with a cross having a single line for one branch and a double line for the other, or in the graphs by a single bold line), that contains respective batteries to enable their chips to operate. The energy for emitting radio waves is provided by a reader 18. The availability of the signal from the RF device 17 is limited to the field of the reader 18. The strength of the signal from the RF device 17 and the strength of the signal required by the reader 18 are medium.

With particular type of RF device 17 (in particular which one of the passive, semi-active, or active technologies “t” is to be used for the labels 17C, 17B, or 17A, respectively) for tracking a given on-board component of the aircraft 1 is determined by the modeling/simulation/optimization operation in accordance with the invention, as a function in particular of criteria such as:

the accessibility of the on-board component, it being understood that RF devices 17 requiring the least intervention and having a long life time are selected for on-board components that are difficult to access, for example;

the environment of the on-board component, it being understood that RF devices 17 having greater emission and reception capacities are selected for example for on-board components in an environment that disturbs those capacities;

positioning proximity, i.e. the potential location for the reader 18 dedicated to communication with an RF device 17, it being understood that the devices 17 having the greatest ranges are selected for example for components where the dedicated reader 18 is the most remote; and

environmental or safety requirements.

However such generalities do not on their own make it possible to devise an identification system 2 that is properly optimized for a given configuration of an aircraft 1.

In FIG. 1, active RF devices 17A are coupled to vital components of the aircraft 1, e.g. to the blades 12 of the main rotor of group 4, to the structure 13 of group 7, and to the skids 14 of group 10.

For semi-passive or active RF devices 17B or 17A that require a power supply that is distinct from the waves via which they communicate, and also for other components of the system 2 that require a power supply that is incorporated in their own structure, for example, provision is made for them to be fitted with or capable of being connected to energy charger devices 30 (FIG. 1, the device 30 is incorporated in the active device 17A of the skid 14).

As mentioned above, the system 2 includes at least one local reader 18, i.e. an on-board reader that is dedicated to recording and/or reading one or more of the (active, semi-active, or passive) devices 17A-C. For these readers 18, the term “transceiver” is sometimes used.

Typically, each on-board reader 18 is located near to or in a functional sector or functional group to which it is dedicated. For example, in FIG. 1, the reader 18 situated furthest to the left is located within the anti-torque rotor functional group 5, and takes charge locally of exchanges or communications with the passive devices 17C of this group.

Thus, a set of marking devices 17A/17B/17C (e.g. the devices of group 5 in FIG. 1) forms one of the nodes 19 on which a mesh in accordance with the invention is based.

Still in FIG. 1, the system 2 includes at least one near-by router 21, i.e. a router that is on-board and dedicated to transmission internal to the aircraft 1 of recordings and/or reading of one or more of the (active, semi-active, or passive) devices 17A-C.

As for the readers 18, each on-board router 21 is located near to or within a functional sector of functional group to which it is dedicated so as to form an intermediate wireless frame 22 (only one of which is shown in FIG. 1, close to the blade 12 of group 4) with a local reader 18.

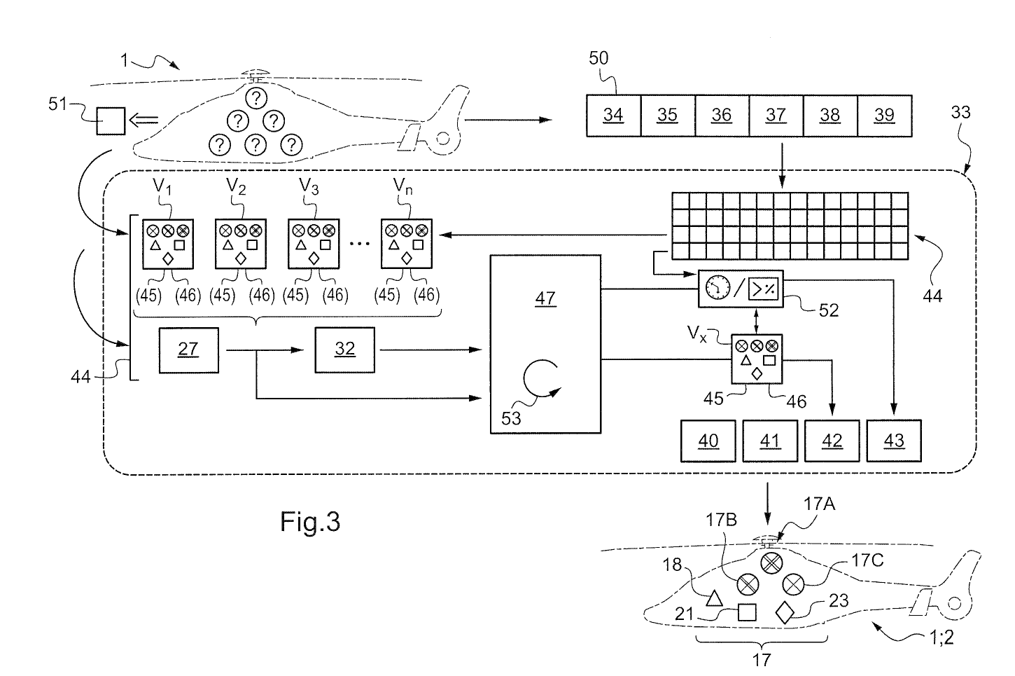

Likewise, each of the systems 2 (FIGS. 1 and 3) presents at least one concentrator 23. Such a concentrator 23 recognizes the various wireless objects (devices 17, readers 18, etc.) that are connected to its local wireless network.

On receiving information (own data 170, FIG. 1) coming from a device 17A-C, e.g. via the near-by reader 18, the dedicated concentrator 23 decodes the header of that information in order to discover its destination and then sends it only to the intended wireless object. This reduces traffic on the network as a whole.

The on-board concentrator 23 co-operates with the routers 21 to form a terminal mesh 24 of a meshed security wireless network, via which network data specific to the components is transmitted between the labels 17A-C and the installation 15 (portion of the system 2 that is external to the aircraft 1).

In the external installation 15, an identification interface communicates (at 29) with a final database 28, e.g. including industrial planning software.

According to a characteristic, at least one marking device 17 (passive electronic label 17C) is exclusively provided with a memory zone that can be read freely.

A procedure for authenticating the RF device 17C is then followed by a procedure for deciphering payload data 170 (FIG. 1).

These procedures are performed remotely via one of the readers 18 (the reader dedicated to the device 17C in question) that is likewise on board. The remote authentication procedure has recourse to an authentication digest in the form of a message authentication code obtained by hashing the payload data 170 as a function of a secret authentication key.

This remote deciphering procedure makes use of a generated value and of a secret deciphering key with a truncated length, as described in document FR 2 925 246.

In this example, the secure wireless communication within the nodes 19 makes use of the UHF frequency range.

However, embodiments make provision, for example, that communication between passive and semi-passive marking devices 17B-C and their readers 18 take place at a frequency of about 869 megahertz (MHz), while the active transponders 17A communicate at a frequency of about 2.4 gigahertz (GHz).

Now that the RF identification technologies have been set out by way of introduction, there follows an explanation of simulation/modeling in accordance with the invention, given initially with reference to FIGS. 3 and 4.

Thus, there are shown in detail the necessary variables 45-46, constraints 27A-G, and input parameters 34-39 that incorporate the physical environment of the aircraft 1.

On the basis thereof, a model founded on a physical equation serves to obtain a first estimate for defining the marking devices 17A-C and/or readers 18 and/or concentrators 23 (and/or routers 21) that are found to be optimal for a given or selected configuration of the aircraft 1.

This gives rise to a decision factor FD01 that is deduced by the invention, which may be of pecuniary order, e.g. such as the cost or the total budget for a system 2. A decision factor such as FD02 may be of quantitative or weight order.

The invention also processes constraints 27 that are taken into account. These constraints 27 show specific features of the invention: that which is sought after compared with that which must be avoided, the minimum requirements that are satisfied by any configuration whatsoever of the aircraft 1, for representing the environment of the aircraft 1 and its RFID system 2.

A “target” function 47 is described in the examples, and in FIG. 3: it gives results that are obtained from modeling the configuration.

It should be emphasized that the modeling/optimization of the invention can be generalized. Not only is it applicable to all types of aircraft 1, it may also be adapted to all systems 2 of similar carriers (cars, etc.). This generalization property is important from the points of view of the repeatability and the credibility of the modeling/simulation/optimization.

From the above, it can be understood that if the RF device 17A-C is in the field of a reader 18, then that device 17A-C can communicate with said reader 18 if such communication is authorized, e.g. same frequency and where necessary authentication agreement, but only if such communication is physically possible.

A constraining environment may prevent or impede the propagation of radio waves between the devices 17.

The data or information 170 coming from the marking devices 17A-C is formatted, filtered, and organized in logical manner by an RF device interface that is also referred to as “interware”. The data is then processed by the final database 28, and in particular by software serving to analyze information (FIG. 1).

The invention naturally relies on simulating problems of radio coverage, since these are determining for the data transmission function. Nevertheless, the invention optimizes and presents various overall or total decision factors (FD01, FD02, . . . ) of a given and complete RFID system 2.

For example, amongst the decision factors, the total weight FD02 reached by the RFID system 2 for installing on board in the aircraft 1 is determined by the modeling/simulation. Thus, comparisons between a plurality of configurations, also referred to as versions V1, V2, V3, . . . , Vx, . . . , Vn (FIG. 3) can be performed in the context of integrating RFID in various aircraft 1. The data defining these various versions V1-Vn is incorporated in the optimization of the invention, e.g. using an interface 44 connected to a tool 33 for automatic comparisons of multiple configurations. Depending on circumstances, this interface 44 is an input interface (keyboard, etc.) or an interface for transferring data within an electronic management environment.

The invention addresses various types of performance (such as those referenced 31 in the graphs of FIGS. 4, 8, and 12) and parameters of the RF devices 17. The invention compares their overall impacts and their differences. The invention leads to a proposal for presenting to deciders on the basis of a study by simulations. Compared with a radio simulation on its own, the following table T1 is obtained:

TABLE T1

| | FD01 | Weight | R/W distance | Number |
|---|---|---|---|---|
| | (U) | (g) | (m) | (17) |
| Version A1 | | | | |
| Passive | 2 | 2 | 0.3 | 66 |
| Semi-passive | 16 | 16 | 0.8 | 130 |
| Active | 100 | 30 | 5.2 | 71 |
| 4 readers | | | | |
| FD01 Total (U) | 15312 | | Error on solution (%) | 0% |
| Total weight (kg) | 6.942 | | Time (52 s) | 27 |
| Version A2 | | | | |
| Passive | 2 | 4 | 0.3 | 66 |
| Semi-passive | 16 | 20 | 0.8 | 130 |
| Active | 100 | 40 | 5.2 | 71 |
| 4 readers | | | | |
| FD01 Total (U) | 15312 | | Error on solution (%) | 0% |
| Total weight (kg) | 8.304 | | Time (52 s) | 73.9 |
| Version A3 | | | | |
| Passive | 0.5 | 2 | 0.3 | 6 |
| Semi-passive | 5 | 16 | 0.8 | 81 |
| Active | 20 | 30 | 5.2 | 180 |
| 1 reader | | | | |
| FD01 Total (U) | 7008 | | Error on solution (%) | 0% |
| Total weight (kg) | 7.808 | | Time (52 s) | 3.7 |
| Version A4 | | | | |
| Passive | 0.5 | 4 | 0.3 | 6 |
| Semi-passive | 5 | 20 | 0.8 | 81 |
| Active | 20 | 30 | 5.2 | 180 |
| 1 reader | | | | |
| FD01 Total (U) | 7008 | | Error on solution (%) | 0% |
| Total weight (kg) | 9.944 | | Time (52 s) | 2.5 |

Table T1 uses an example of the invention to show how it presents the following advantages in particular:

comparison and optimization of a plurality of potential technologies for the devices 17 (performance, weight, and other decision factors);

total impact of a decision factor (e.g. the factor FD01 incorporated as the target function);

impact of a total weight decision factor FD02 (incorporated in the model as a constraint); and

help in decision-making.

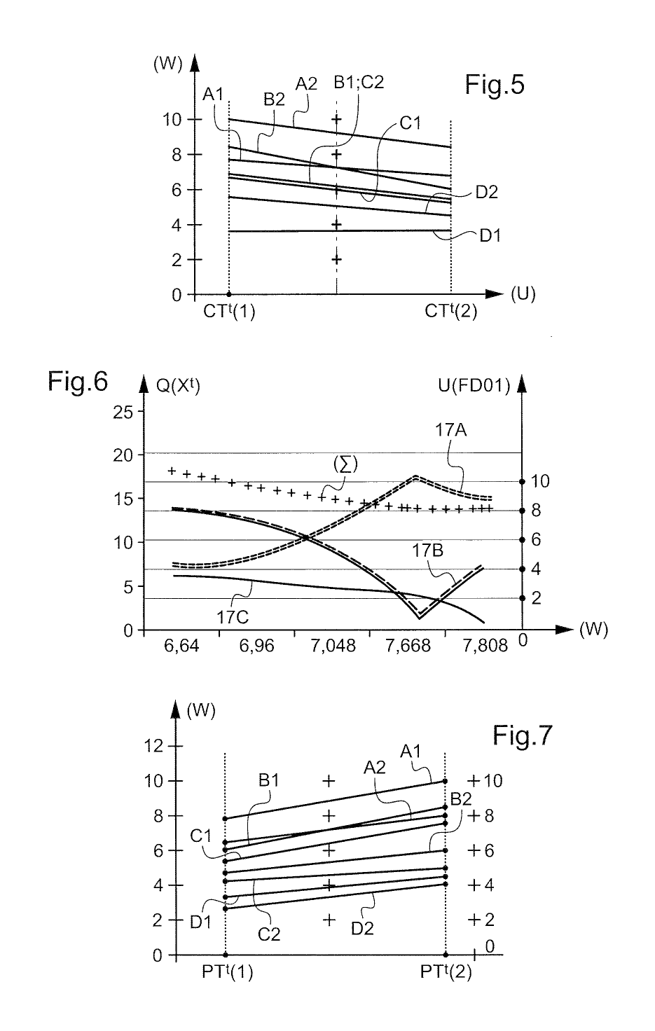

In Table T1, there can clearly be seen the various possible versions or configurations: A1, A2, A3, and A4. Examples of other versions (B1, B2, C1, C2, D1, D2) are also shown in the graphs of FIGS. 5 to 13.

In Table T1, there can be seen columns (from left to right) that indicate: a decision factor FD01 (e.g. the accessibility of on-board mounting or the value of the device 17); a weight in grams (g) for each device 17; the R/W distance in meters (m) which designates the acceptable range between a device 17 of a given type (technology “t”: passive, semi-active, or active) and its allocated reader 18 (within one of the groups 4-11); and the total number of devices 17 within the version A1, A2, A3, or A4 under consideration for the system 2.

In its rows, the following can be seen going from top to bottom: the number of devices 17 in the system 2 organized by technology type (“t”: passive, semi-passive, or active); the number Q of reader(s) 18 for the version; the total value of decision factor FD01 (units “U”); and the total weight in kilograms (kg) of all of the devices 17 of the total system 2 as simulated in each version (decision factor FD02). There can also be seen a “gap” or error value relative to the optimum solution (in percentage) that is obtained for the result. Finally, a value is given for the total processing time (in seconds, “s”).

Whereas a radio simulation gives only the coverage (with a binary yes/no response) of a specific label relative to a specific transceiver in a specific configuration, the invention provides numerous other responses that make it possible in simple, fast, and economic manner to determine the feasibility of installing an envisaged version (A1-A4 for example) of a system 2 on an aircraft 1.

The table T1 makes it possible to visualize and decide between four configurations (versions A1-A4).

The invention naturally does not seek to present RF simulation as being useless, but rather as a complement to the modeling/simulation specific to the invention. In order to operate, a system 2 requires its RF behavior to be validated as being perfect. RF simulation is thus incorporated in the invention and serves to optimize the options that might be envisaged relative to the best decision factor values and with a good estimate of what is going to happen in “reality”.

By way of example, attention is given below to various distributions within a particular aircraft 1 of the devices 17A-C, for each group.

In an envisaged version, the following performance is given:

TABLE T2

| Technology | R/W distance |
|---|---|
| (<< t >>) | (m) |
| Passive | 0.3 |
| Semi-passive | 0.8 |
| Active | 5.2 |

In one example, five groups are formed, namely:

structural, mechanical, electronic (pilot assistance, etc.), electrical equipment (lamps, etc.), engine. Each group may include at least one passive, semi-active, or active device 17A-C. In association with each group, the various devices 17 are listed by general location. Then, for each located device 17, various criteria are defined, including:

presence/absence of a dedicated reader;

distance of each device 17A-C relative to its allocated reader 18 (in meters); and

actual power of each of the readers 18 for each of the devices 17A-C (in units determined as a function of an RF simulation).

As stated above, the optimization modeling/simulation of the invention relates to optimizing choices made relating in particular to the positions of the readers 18, and of the devices 17, and to the technologies “t” used therefor (passive, semi-passive, or active).

The modeling/simulation variables of the invention are determined from a list 51 of components for marking in the given configuration for the aircraft 1. Even if this is not a key factor, the potential costs and advantages (e.g. saving in maintenance time, increase in availability for the aircraft 1, ease of configuration changing, etc.) perform non-negligible roles at an industrial level. Consequently, where necessary the modeling makes it possible to visualize and thus to minimize costs concerning decision variables 45 and state variables 46. It should be observed that the values that are finally produced for these variables 45 and 46 are binary (0/1), in accordance with the invention.

Relating to these decision variables 45 as shown in FIG. 3, there can be seen the variable concerning the positioning of the readers or transceivers 18:

[symbol]

=1 if the location “j” is retained for a transceiver (18); else=0.

Another decision variable 45 is the positioning of the data concentrator unit (DCU) 23:

[symbol]

=1 if the location “j” is selected for the DCU; else=0.

Another decision variable 45 is selecting the positioning and the technology of the devices 17, whence:

[symbol]

=1 if the technology “t” is retained for a device 17 at the node “i” (19); else =0 (given that each device 17 has a specific technology associated therewith). In examples, the positions/locations are expressed together with the selected technologies “t” and vice versa.

As for the state variables 46, the invention incorporates the coverage (read/write feasibility) of a label “i” by the transceiver present at the site “j”:

[symbol]

=1 if the transceiver at location “j” covers the label at node “i” (19); else =0.

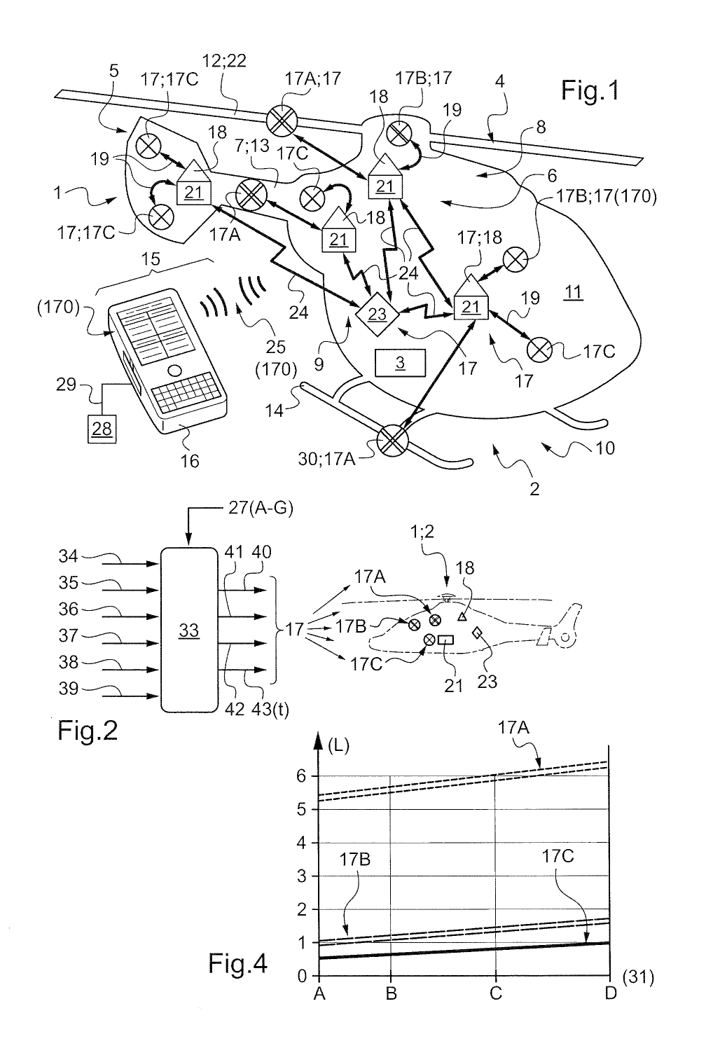

The invention requires various input parameters (34-39) to be entered into the automatic tool 33 (FIGS. 2 and 3), some examples of which are described below. The tool 33 also provides various results (40-43; 45-46), in particular in terms of positioning and choice of technology “t”. It is this tool 33 that mainly implements the simulation/modeling method in accordance with the invention. Typically, the tool 33 is a computer having a software suite for automatically comparing multiple configurations.

With reference in particular to FIG. 2, there follows a description of various input parameters needed by the tool 33 in order to implement the simulation/modeling in accordance with the invention. These input parameters (34-39) include various decision factors relating to overall (i.e. total) compatibility of the RF devices 17 (17A-C; 18; 21; 23) of the system 2.

For example, in FIG. 3, these parameters are as follows:

parameter 34: cost of the devices 17 as a function of the technologies “t” selected for the marking devices 17A-C;

parameter 35: weights of the devices 17 as a function of the technologies “t” selected for the marking devices 17A-C;

parameter 36: maximum weight authorized for the system 2 in the given configuration of the aircraft 1;

parameter 37: list of on-board components to be tracked for the given configuration of the aircraft 1, this list contributing to defining the various achievable profiles V1-Vn (FIG. 3);

parameter 38: available or potential positions for the devices 17; and

parameter 39: coverage of each marking device 17A-C by a potential near-by reader 18.

In order to optimize the decision and state variables 45 and 46, the tool 33 requires various parameters (34-39) relating to the context of the aircraft 1 and to the RFID system 2 to be entered or input into the interface 44. In another example of the invention, these parameters that are taken into account are the following profiles.

A parameter written “CLⱼ” in the equations below that designates a total decision factor (compatibility, cost, possibility of being installed, etc.) for the reader 18 or transceiver, e.g. calculated as the sum of the decision factor specific to the transceiver, plus the decision factor for its associated technology and/or maintenance.

A parameter written “CDCUⱼ” in the equations designates another total decision factor (compatibility, cost, possibility of being installed, etc.) for the concentrator(s) 23 on board the aircraft 1 in order to obtain the system 2. For example, this parameter CDCUⱼ is calculated as the sum of the decision factor specific thereto plus the factor relating to the maintenance associated with the concentrator(s) 23.

A parameter written “CT^{t}” in the equations designates a total decision factor (compatibility, cost, possibility of being installed, etc.) for the devices 17A-C coupled to the on-board components of the aircraft 1 in order to obtain the system 2. For example, this parameter is calculated as the sum of the decision factor specific to the set of devices, plus the factor for the maintenance associated with the devices 17A-C and with the associated technology choice.

The parameter 39 written “αᵢⱼ^{t}” in the equations designates a coverage factor for a device 17A-C and a node (19) referenced “i” using the associated technology “t” by means of a reader 18 placed at a location “j”: this coverage depends in particular on: zoning; confinement; materials (both of the equipment and of the environment); distance; requirements (environmental, safety, etc. constraints); the type “t” of technology that is selected; and each physical constraint in general.

A parameter written “S” in the equations is a factor defining the number of locations available for the various readers 18, concentrators 23, and optionally routers 21.

A parameter written “N” in the equations, designates a factor defining the number of on-board components or pieces of equipment that are tracked (in general the number of paired devices 17A-C) for the aircraft 1 under consideration in the study.

Other parameters representative of decision factors are incorporated in the examples of equations in accordance with the invention, and they include: a parameter for the maximum available weight onboard the aircraft 1, written “β”; a parameter for the weight of the reader 18 (transceiver) written “PL”; a parameter for the weight of the concentrator 23, written “PDCU”; and a parameter written “PT^{t}” in the equations designates the weight of each on-board device 17A-C as a function of its technology “t”.

In order to obtain good accuracy for the method and thus a realistic estimate, the invention makes provision for introducing physical equations in order to estimate correctly the coverage (or non-coverage) of an RF device 17A-C coupled to an on-board component for a specific reader 18 (estimation of the coverage parameter of a label at node “i” (19) with the associated technology “t” (39)).

In an example, the physical equation used relies on the power received by a dedicated reader 18 from the return signal. The reader 18 emits signals in the form of radio waves in the air. If an on-board device 17A-C lies in the field of such a reader 18 and if the power it receives is satisfactory, then the device 17A-C can respond to said reader 18. The power delivered by the device 17A-C must be sufficient to return the information (170) to the reader 18 at some particular distance from the device 17A-C. In this example, the invention bases its approach on the minimum power received by the reader 18 relating to the response from the device 17A-C.

In spite of its simplicity, the method of the invention gives a good estimate of what really occurs with radio waves. Furthermore, its model is not frozen. It is therefore possible to cause the invention to progress in order to study the impacts of modifying the read/write distance on the results obtained. As technology progresses, the invention can offer a tool 33 that makes it possible to evaluate the impact of performance variations on the decision factors for the overall system 2.

In this example, the model relies on a Friis equation written in the following form:

$${P}_{r} ( d ) = \frac{P t G t G r λ}{{( 4 π )}^{2} {d}^{2}}$$

This equation is commonly used in telecommunications, and it gives an order of magnitude for the radio power picked up by a reader 18 situated at a certain distance “d” from a device 17A-C in free space. It should not be confused with the Friis formula that is used for calculating the noise factor of a system. In the context of the invention, for a distance d, the value “Pt” of the transmitted power, and Pr(d) corresponds to the power received (at distance “d”), Gt corresponding to the gain of the reader 18, Gr corresponding to the gain of the device 17A-C, d corresponding to the transmitter to reader distance, and λ corresponding to the wavelength (directly associated with the frequency used).

In addition, the attenuation due to the metallic environment is taken into account by the invention. This attenuation expresses the difficulties involved in transmitting and propagating the signal.

Finally, the invention considers most or even all of the constraints surrounding the system 2 in order to obtain a good simulation and a good estimate of what really happens. In addition, differences in terms of technological performance are given with this “physical” consideration. Thus, the solutions of the model show impacts in terms of quantification. The results are set out below.

It can be understood that with the invention, as shown in FIG. 3, the results may take meaningful values as follows:

40 for the position of each reader 18 and the associated technology;

41 for the position of each data concentrator 23 and the associated technology;

42 for the position of each device 17A-C in the aircraft 1; and

43 for the technology “t” selected for each of the devices 17A-C.

In certain embodiments, the method incorporates a function 47 (FIG. 4) representative of targets previously set for the identification system 2.

In an industrial context and in order to achieve acceptable return on investment, optimizing decision factors (costs) is a lever of considerable importance for introducing a technology. In these examples, the function in question is represented for the tool 33 in the form of the following equation (target function 47):

$$Min ( {\sum }_{j =}^{S} C {L}_{j} {Y}_{j} + {\sum }_{j =}^{S} C D C {U}_{j} {D}_{j} + {\sum }_{i =}^{N} {\sum }_{t =}^{T} C {T}^{t} {X}_{i}^{t} )$$

This target function 47 leads to minimizing the decision factors (e.g. costs) as a function of the positioning of the coupled devices 17A-C, of each reader 18 with its router 21, and of each data concentrator 23, and as a function of the chosen technology “t”.

In order to solve this target function 47, one implementation provides for having recourse to a linear solver for the equation. Such a solver incorporates values for each variable during resolution in order to determine an optimum solution (if there is one) in the end. Conventional solvers are available for this purpose, e.g. linear resolution software such as

Xpress-Mp or ILOG Cplex, which may be dedicated to a conventional spread sheet, e.g. of the OpenOffice or analogous type.

When optimization is performed by the method of the invention, the results are the value of the target function 47 (total costs of the identification system 2), the results for the decision variables 45 (positioning and choice of technologies for the readers 18, routers 21, concentrator 23, and the devices 17A-C, with each chosen technology “t”) and the constraint values 27 when necessary (e.g. the constraint 27E relating to total weight β of the system 2).

The invention is also remarkable in the way it takes into consideration in simple and effective manner constraints 27 relating to the context in which the identification system 2 is used.

Below reference is made to results of optimizing the problem that must correspond to the following specific constraints 27A-G in the context of use in aviation. Sometimes constraints 27E and 27F are optional. These constraints 27 are defined on the grounds of the operating needs of the overall identification system 2 and of its incorporation in the aircraft 1.

One of the constraints 27A relates to total coverage: it must be possible to read each item of data coming from a device 17A-C of the aircraft 1, e.g. such as each point “i”, from at least one location “j”: in the invention this is represented by the following equation:

$${\sum }_{j = 1}^{S} {Z}_{ij} \geq 1 ∀ \text{?} … , N \text{?}$$

$$\text{?} \text{indicates text missing or illegible when filed}$$

Another incorporated constraint 27B seeks to limit the number of on-board readers 21 (“α” is the maximum number of readers 18 to be installed in the aircraft 1):

$${\sum }_{j = 1}^{S} {Y}_{j} \leq α .$$

Another constraint 27C imposes a restriction to only one concentrator 23 on board the aircraft 1, and this is written:

$${\sum }_{j = 1}^{S} {D}_{j} = 1.$$

A constraint 27D specifies the selected technology “t” that is best studied for each marking device 17A-C: each device 17A-C must be associated with one technology “t”, and this is written:

$${\sum }_{t = 1}^{T} {X}_{i}^{t} = 1 ∀ \text{?} … , N \text{?}$$

$$\text{?} \text{indicates text missing or illegible when filed}$$

It is emphasized that this constraint is given solely by way of example, and that the constraints 27 of the invention give choices of technology “t” for all of the devices 17, regardless of whether they are labels and/or readers 18 and/or routers 21 and/or concentrators 23. The same applies for all of the constraints 27A-G, where appropriate.

According to a constraint 27E, if a marking device 17A-C at node (19) is covered by a given reader 21 positioned at location “j”, then that position “j” must cover this device 17A-C, here written “i”, and its associated technology “t”, given that the technology “t” has been selected. This is written:

$${Z}_{ij} \leq {\sum }_{t = 1}^{T} {a}_{ij}^{t} {X}_{i}^{t} ∀ \text{?} … , N \text{?} ∀ \text{?} S \text{?}$$

$$\text{?} \text{indicates text missing or illegible when filed}$$

According to a constraint 27F, if the marking device 17A-C referenced “i” is covered at the node (19) by its near-by reader 21 available at the location “j”, then at least one reader 21 (or the concentrator 23) is positioned at this node 19 at its location “j”:

[symbol]

This is referred to as the coverage condition constraint at Zᵢⱼ.

A constraint 27G that is typical in aviation is the limit on the amount of weight that can be added to the aircraft 1, referred to as a “boundary marker”. This is referred to as the positioning convergence constraint relative to the node 19 as Zᵢⱼ. The maximum authorized on-board weight for the identification system 2 (maximum for safety, fuel consumption, and payload reasons) is written β, and thus:

$$PL {\sum }_{j = 1}^{S} {Y}_{j} + {\sum }_{i = 1}^{N} {\sum }_{t = 1}^{T} {PT}_{i}^{t} {X}_{i}^{t} + PDCU \leq β .$$

In FIG. 3 or 4, the example of the invention may be summarized as follows.

In one aspect, the invention provides a method of modeling and optimizing an identification system 2.

In this method, starting from an inventory 51 (FIG. 3), the following are predefined: components (4, 10, 12-14) for identification, and a list 50 of “modeling” input parameters 34-39. Also predefined is the series 27 of functional constraints 27A-G appropriate for the selected or given configuration.

The list 50 and series 27 are run through (i.e. translated) to model a plurality of potential profiles V1, V2, Vx, . . . , Vn of an identification system 2. A set of decision variables 45 and a set of state variables 46 correspond to each potential profile V1 . . . Vn. In the examples, this produces about 9000 potential profiles, which excludes any optimized selection.

The set of decision variables 45 comprises at least:

a decision variable representative of the suitability or unsuitability of a possible position for each on-board RF device 17; and

a decision variable representative of a range of possible technologies “t” that can be selected for each on-board device 17.

The set of state variables 46 comprises at least one variable representative of the real radio coverage or non-coverage by its near-by reader 18 concerning each device in the form of an electronic label 17A-C, at a potential position.

In the method, said plurality of potential profiles V1-Vn is sorted as a function of said series 27 of functional constraints 27A-G in order to define a restrictive group 32 of acceptable versions. This sorting serves to reduce the number of options for analysis drastically.

Thereafter, a target function 47 and the series of constraints are applied to automatic comparison (33) of multiple configurations.

This comparison determines an eligible version Vx from within the restricted group 32. This determination is performed by calculation to resolve said target function 47.

The eligible version Vx is optimized for decision and state variables (45, 46) having values that are of binary order.

The target function 47 optimizes at least one decision factor (FD01, FD02) that is determining for the selected configuration for the aircraft 1, overall.

In an example, the target function 47 is applied by determining a so-called “partial” eligible version Vx. For this partial eligible version Vx, the resolution calculation provides real values for the decision and state variables 45 and 46. Furthermore, the target function 47 is also applied until at least one (retained) eligible version Vx has been determined that has binary values for the decision and state values 45 and 46. The respective decision factors are close for the retained and partial eligible versions.

An at least partial eligible version Vx is determined by applying the target function 47 and the constraint series 27 when at least one as-is election recommendation 52 (also called “instant set-point”) is reached by the automatic comparison 33. For example, the election recommendation 52 comprises at least: one error value at the optimized solution derived from the target function 47 and/or a predetermined value for duration of processing by the automatic comparison 33.

On reaching the recommendation 52, it is determined whether this eligible version (Vx) enables optimized values to be delivered for the decision and state variables 45 and 46, but of binary order (0/1).

An example of the method of the invention provides for adjusting the series 27 of functional constraints. This adjustment relaxes at least one (27A-G) of the constraints 27. In an implementation, the series 27 of functional constraints (27A-G) is scanned through in order to progressively adjust said series (reduce/increase values, e.g. the acceptable weight of the system 2), and thus accelerate determining an eligible version (Vx) that has binary variables.

Often, the constraint values of the list (27) are selected from:

the actual coverage (27A) of each device in the form of a label (17A-C) by a reader (18);

a limit (27B) on the total number of readers (18) for the selected configuration;

a restriction (27C) on the total number of concentrators (23) for the selected configuration;

the actual association (27D) of a technology (t) selected for each RF device (17);

a coverage condition (27E) between label form device (17A-C) and reader (18);

convergence (27F) of the positions of each label form device (17A-C) and its reader (18); and

total weight boundary marker (27G) for the identification system.

In order to determine the actual radio coverage state variable binary values for each device (17A-C) in the form of an electronic label by its reader (18), the automatic comparison 33 incorporates a Friis equation function in the determination. This Friis equation evaluates the powers transmitted and received by each on-board radio device 17 or 18.

With reference to the graphs of FIGS. 4 to 12, there follows a description of examples of making use of the results of the modeling/optimization method in accordance with the invention.

The main targets of the method seek to provide decision-takers with advice and scenarios in an industrial context. For the various proposed scenarios, impacts are evaluated and a realistic comparison is proposed. Thus, the advantages and drawbacks of each scenario are presented so as to provide assistance in rating, validating and decision-making.

At this stage, we specify the parameters selected and the assumptions made. The costs of electronic devices (17, 18, 21, 23) vary enormously over time. With present technical progress, the invention makes it possible to influence the work of the supplier concerning the performance of the marking devices 17A-C (read/write distances), their weight, and their costs, by showing up their different impacts on the identification system 2.

Insofar as these various parameters influence results and choices, the cost limits (lower and upper) associated with the system 2 can be defined by the invention, for a potential call for tenders. The total cost limits may make it possible to perform a study of return on investment for the internal needs of the systems integrator or for the customer services and support.

The costs considered in the example (e.g. up to 20 monetary units) appear to be very high compared with the RFID market. However, in an aviation context, certification problems give rise to higher costs. The marking devices 17A-C are incorporated in an aircraft 1 and they must be sufficiently reliable and robust to enable them to be validated by certification authorities (FAA).

Examples of the costs used are as follows:

case 1: passive marking device 17C=0.5 U, semi-passive device 17B=5 U, and active device 17A=20 U, and

case 2: passive marking device 17C=2 U; semi-passive device 17B=16 U, and active device 17A=100 U.

These costs depend on the performance, the ability to withstand a hostile environment, the weight, and the market on offer. They are evaluated with suppliers. At this stage, the target is to estimate in “relative” manner the impact of these costs on the overall system 2.

Furthermore, it is known that the weight of each marking device 17A-C depends on its packaging. This packaging protects the identification device 17A-C in hostile environments. This protective packaging may be thin or thick, light or heavy, depending on the quality of the materials and the location (zoning) of the labels. The battery (if any) plays a considerable role in determining the weight of active and semi-passive marking devices 17A and 17B. After a study with suppliers, the comparative possibilities are as follows:

weight 1: passive marking device 17C=2 grams (g), semi-passive device 17B=16 g, and active device 17A=30 g; and

weight 2: passive marking device 17C=4 g, semi-passive device 17B=20 g, and active device 17A=40 g.

This might seem considerable compared with what can be found at present on the market, but it should not be forgotten that the packaging associated with each marking device 17A-C serves to guarantee that it is capable of withstanding hostile conditions of use.

Insofar as the devices 17 available on the market are changing constantly in terms of performance, the invention provides for several eventualities. In FIG. 4, there can be seen a graph that shows performance per type of technology for a device 17A-C in an example identification system 2.

In FIG. 4, the performance 31 of such a device 17A-C is evaluated (up the ordinate) in distance units L, in each of four performance cases A-D that are predefined as follows.

These distances correspond to the read/write function when a marking device 17A-C is fastened against an on-board component that is made of metal (given that metal “absorbs” radio waves and the performance is thus not as good as it would be in a free space environment). The environment of the aircraft 1 with its numerous on-board components made of metal and its considerable confinement, is likewise very constraining. That is why the performance taken into consideration is not as good as the performance that can be found in the field of logistics and in other fields (where RF devices are used most of the time on cardboard).

In FIGS. 4 to 12, the graphical evaluations (case A, active devices 17A and semi-passive devices 17B in FIG. 3, for example) represent the “lower performance” technologies. The passive performance 31 therein is 0.3 m, the semi-passive performance is 0.8 m, and the active performance is 5.2 m.

Other graphical evaluations (case B) represent technologies of an intermediate class. The passive performance is then 0.5 m, the semi-passive performance 1 m, and the active performance 5.5 m.

Other graphical evaluations (case C) represent technologies of an intermediate class: the passive performance is 0.7 m, the semi-passive performance is 1.3 m, and the active performance is 5.7 m.

Finally, other graphs (case D) show the “highest performance” technologies. The passive performance is then 1 m, the semi-passive performance 1.5 m, and the active performance 6 m.

In a pilot example, that kind of performance appears to be achievable and the present invention appears to come as close as possible to reality.

These assumptions have been taken into account in order to make a satisfactory comparison of the results obtained by the invention. The proportionality between the assumptions A, B, C, and D has been maintained, as shown in the graph of FIG. 4.

This FIG. 4 shows the performance of the various marking devices 17A-C taken into consideration by the invention. This performance complies with practice for UHF RFID labels stuck on conventional metal items. By using the various parameters (cost per technology, weight per technology, and performance per technology), it is possible to compare the results that are obtained. The invention shows the impact of each parameter on the decision factors and on the total weight.

Interpretation of the results is described below with reference to the example of FIG. 5.

Relating to the impacts of total weight and to the analysis in terms of how the parameters vary, the example in question shows the following. If the cost per technology is high—FD01(2)—, then the results of optimization minimize the total cost for most of the readers 18 and a technology of “lower” class. This means that there are numerous passive and semi-passive marking devices 17C and 17B compared with active devices 17A.

In contrast, if the cost per technology is low —FD01(1)—, then the smaller the number of readers 18, the better, since the costs of the marking devices 17A-C are low. Thus, the selected technology class is “high”.

There are more active devices 17A than passive and semi-passive devices 17C and 17B. This makes it possible to reduce the total cost of the system 2. Under such circumstances, because of the large quantity of active devices 17A, the total weight is greater than in the preceding circumstances, even though there are fewer transceiver readers 18.

In the example of FIG. 5, the total weight compared with technology costs is shown. As shown in this FIG. 5, when the cost per technology increases from cost 1 to cost 2 (CT^{t}(1) to CT^{t}(2)), the total weight decreases. The cost per technology has a major influence on optimization. It should be recalled that the target function 47 (FIG. 3) seeks to optimize the identification system 2, e.g. in budget terms. In certain optimization procedures, weight is merely a constraint, and it remains secondary compared with other decision factors. Here, care is taken merely to ensure that certain weight requirements are complied with.

Although it is desirable to reduce the maximum weight authorized in the aircraft 1, it is necessary to reduce the associated S parameter. The simulation of the invention can then be forced to optimize other decision factors while considering a higher weight constraint.

When the value of the weight constraint is reduced, then logically other factors also vary. The technology choices vary to reach the configuration obtained with FD01(2) as the parameter. This specific case (cost 2) presents technology costs that are high. That is why, in terms of decision factors (and thus weight), it represents the optimum situation. This is shown for example in FIG. 6 where a total cost is compared relative to the minimum weight reached (variation of the constraint).

Considering the left-hand portion of the graph (up to 7 kg), it can be seen that if the minimum weight achieved decreases, then the number of passive and semi-passive marking devices 17C and 17B increases to the detriment of active devices 17A. In parallel, the number of readers 18 is greater: 7.8 W reached with a single reader 18, whereas the weight is 6.94 W with four readers 18. Consequently, the greater the number of readers 18, the greater the cost. As a result, this costs more than increasing the “class” of the marking devices 17B-C.

The graph of FIG. 6 also shows that on going from 7.8 W to 7 W (saving 0.800 W), the increase in pecuniary units is about 600 U. On going from 7 W to 6.94 W (saving 100 g), the pecuniary increase is 2000 U. From a decision-making point of view, the first improvement may be advantageous, whereas the second presents little advantage.

Variation in the total weight compared with variation in weight per technology increases in substantially the same manner for each technology (FIG. 7). No configuration presents any particular advantage from the weight optimization point of view.

FIG. 6 thus shows the total weight relative to the weight per technology. The following graph (FIG. 7) shows the variation in total weight relative to performance parameters.

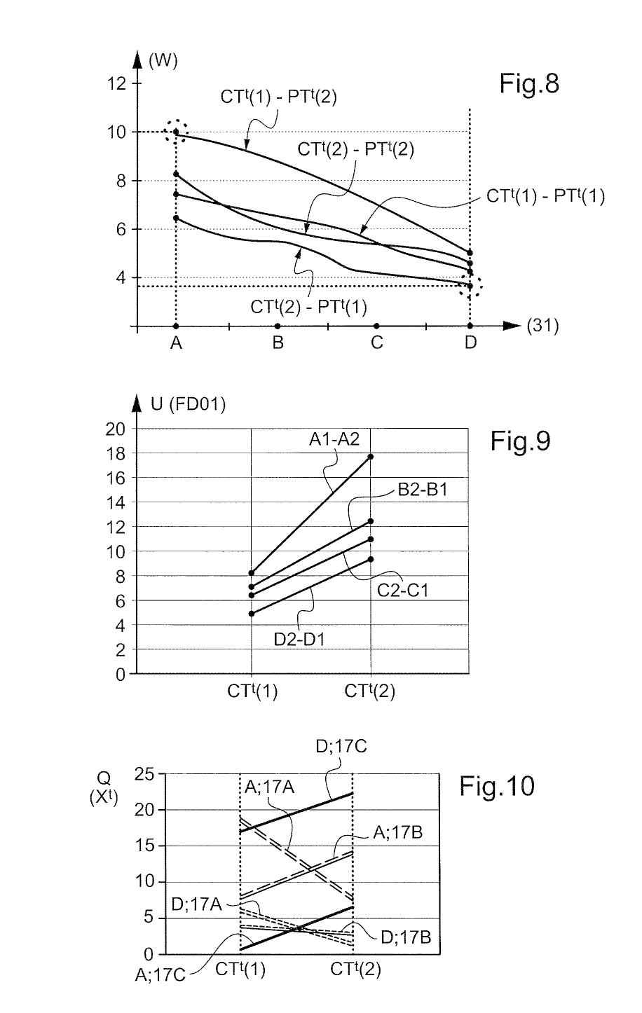

FIG. 8 shows the total weight relative to technological performance. This graph shows that an increase in the performance of the marking devices 17A-C gives rise to a better impact on weight in the aircraft 1. With good performance for the marking devices 17A-C, the manufacturer of the aircraft 1 can expect a weight impact of about 4 W. However, in the least favorable case considered, this impact may be as much as 10 W. This impact is considerable for an aircraft 1. The advantages of improving the performance of the marking devices 17A-C are considerable both for the manufacturer of the aircraft 1 and for the client.

Below we consider the impacts of total cost and how they can be analyzed when parameters vary. This cost per technology clearly has a considerable impact on the total cost of a system 2 (FIG. 9). FIG. 9 shows the total cost compared with the cost per technology “t”. FIG. 9 shows that the increase in total cost is greater in case A than in cases B, C, and D.

Between the performance indicators CT^{t}(1) and CT^{t}(2), the choice of technology is not the same for optimizing total costs. In case A, the index CT^{t}(1) concerns a majority of active marking devices 17A and a single reader 18. For cost 2, the number of semi-passive marking devices 17B is high, and four readers 18 are required. Technology choices change strongly between these two cases.

For case D, most of the marking devices 17 are of the same type as for cost 1. For cost 2, where most of the marking devices 17 are passive, the number of readers 18 used differs relatively little. That explains why curve A has a sleeper slope than curve B in FIG. 10.

FIG. 10 shows the variation in the number of marking devices 17A-C for cases A and D. By way of information and for relative analysis, the total number of marking devices 17A-C taken into consideration in a prior feasibility study of the invention was 267 for this configuration of aircraft 1.

In FIG. 10, there can be seen an example of technology choices compared with cost, per technology. The curves labeled “A; 17A”, “A; 17B”, and “A; 17C” (case A, CT^{t}(1), to the left), show that most of the marking devices 17A-C do indeed change from the active type to the semi-passive type. In case D (CT^{t}(2), to the right), the marking devices 17 remain of the passive type 17C. It is also possible to see that the slopes of the curves in case A are steeper than the slopes of the curves in case D. This shows the constancy of technology choices for case D.

In FIG. 10, it can also be seen that the costs remain identical for different weights per technology. FIG. 10 shows this with greater accuracy. This means that the chosen technologies “t” (for the active marking devices 17A, semi-passive devices 17B, or passive devices 17C) remain the same, even if the weight varies. This shows, once more, that optimizing for cost is more important than optimizing for weight in the method of the invention.

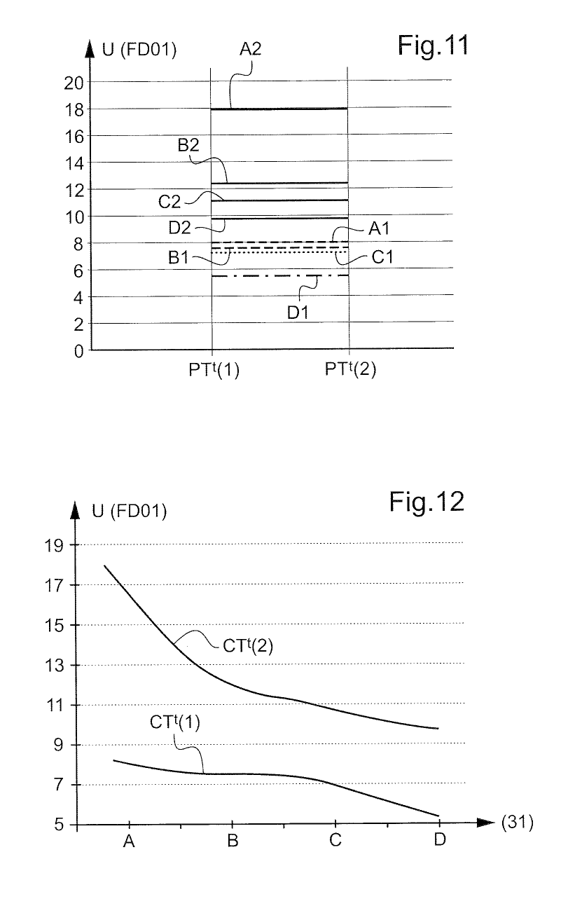

FIG. 11 shows variation in total cost relative to weight per technology. FIG. 11 also shows that if the performance of the marking devices 17A-C varies, their costs decreases. The best performance is represented by a smaller number of readers 18 incorporated in the system 2 and technologies of lower “class” can be selected: this selection leads to a majority of passive or semi-passive marking devices 17C or 17B, and relatively few active marking devices 17A.

In this example, while total cost remains identical, total weight varies (see FIG. 7). The difference of the variation between the two curves (cases A1 and A2) and the two curves (cases D1 and D2) is considerable. The same applies to the two curves CT^{t}(1) and CT^{t}(2) in FIG. 12. For the case A, four readers 18 are needed to be used for cost 1, whereas only one reader 18 is required for cost 2. For case D, four readers 18 are needed for cost 1, and only two readers 18 for cost 2. Thus, the difference in terms of the number of readers 18 is smaller. Furthermore, the majority class of the marking devices 17A-C varies considerable for case

A and remains identical for case D (using passive devices 17C). This variation (or lack of variation) in the elements of the identification system 2 is thus transferred to the overall results.

FIG. 12 shows the variation of total cost relative to technological performance. A comparison of total costs for different levels of performance shows considerable relative variation (FIG. 12). This reduction is greater for high cost per technology (cost 2) than for low cost (cost 1). The main influence comes from the number of marking devices 17 that pass from active type 17A to passive type 17C (e.g. between cases A and B). For cost 1, the improvement in terms of performance (from A to C) does not have any considerable effect on the total cost.

It is possible to conclude as follows. The present invention shows that the solution selected for optimization and the results obtained. The prior art problems have thus been resolved, concerning the positioning of the readers 18 and of the data concentrators 23, the marking devices 17A-C, and relating to the technologies “t” selected for these devices (automatic identifier). These results provide the systems integrator (e.g. the program director) with elements on which to make decisions more accurately than with known solutions. With the invention, a plurality of parameters are taken into account and estimated and the impacts of variations are evaluated. As described in detail above, the invention shows that the optimization method provides estimates that are useful and effective in terms of impacts and in assisting decision making. It is important to concentrate on the main influential factors and to estimate the impacts thereof. These are the factors that are key factors in terms of decision making.

Furthermore, these results are important for interactions with the people in charge of several activities. The invention provides data to the systems integrator whose remarks are then taken into account. This makes it possible to increase the credibility of the model which then becomes more convincing as a result of repeated exchanges. Finally, the model may be extended to a variety of identification systems, e.g. systems that are more complex. It is possible to add options in the aircraft 1 and simple manipulation (modification via 44) makes it possible to adapt the optimization as a function of such additions. It is also possible to incorporate new potential and/or developed technologies—such as sensors communicating via radio waves—thus illustrating the vast capacities of the invention to adapt. The system 2 that is obtained incorporates RFIDs and may be presented in numerous forms, for vehicles such as cars or trains, other than aircraft 1 (rotary wing or fixed wing).

By taking account of constraints that are pertinent given the targets that have been set (for several versions in parallel), the invention serves to refine results by successive iterations and interactions (as often as necessary), where such iteration in possibly successive loops is represented by arrow 53 in FIG. 3.

The invention is nevertheless not limited to the implementations described. On the contrary, it covers all equivalents of the characteristics described.

What is claimed is:

1. A method of modeling and optimizing an RF identification system comprising a plurality of on-board components in a selected aircraft configuration; the system comprising at least:
two RF devices, each in the form of an electronic label coupled to an on-board component, an RF device in the form of a local reader, and an RF device in the form of a compatible wireless data concentrator and connected to said local reader;
said reader being compatible with and near at least one of said devices in the form of an electronic label, wherein starting from an inventory of on-board components that are to be identified, an input list is predefined of “modeling” parameters and a series is predefined of functional constraints that are appropriate to said aircraft configuration;
said list and series are run through to model a plurality of potential profiles of identification systems, each potential profile having: a set of decision variables and a set of state variables; said set of decision variables comprising at least:
a decision variable indicative of the suitability or unsuitability of a possible position for each on-board RF device;
a decision variable indicative of a range of possible technologies that can be selected for each on-board device; and said set of state variables includes at least one variable indicative of the real radio coverage or non-coverage of each device in the form of an electronic label at a possible position by means of its near-by reader;
said plurality of potential profiles is sorted as a function of said series of functional constraints to define a restricted group of acceptable versions; and
then a target function and said series are applied to automatic comparison of multiple cases in order to determine an eligible version from within the restricted group by calculation to resolve said target function;
said eligible version being optimized for decision and state variables having values of binary order;
said target function optimizing at least one decision factor that is determining for the selected aircraft configuration as a whole.

2. A method according to claim 1, wherein said target function is applied by determining a “partial” eligible version for which said resolution calculation provides real values for the decision and state variables; said target function being applied again until at least one eligible version has been determined that has decision and state variables with binary values, and for which the respective decision factors are close together.

3. A method according to claim 2, wherein an at least “partial” eligible version is determined by applying the target function and said series of constraints, when at least one election recommendation is reached by said automatic comparison of multiple cases, after which it is determined whether this partial eligible version makes it possible to provide optimized values of binary order for the decision and state variables.

4. A method according to claim 3, wherein the election recommendation comprises at least:
an error value at the optimized solution derived from the target function and/or a value for the duration of processing by the automatic comparison.

5. A method according to claim 1, providing for an adjustment of the series of functional constraints by relaxing at least one of the constraints; for example a scan is made through the series of functional constraints in order to proceed with progressive adjustment of said series, and thus accelerate determining an eligible version having binary variables.

6. A method according to claim 1, wherein the constraint values of the list are selected from: the effective coverage by a reader of each device in the form of a label; limiting the total number of readers for the selected configuration; restricting the total number of concentrators for the selected configuration; effective association of a choice of technology with each RF device; coverage ability between the device in the form of a label and the reader; convergence of the positions for each device in the form of a label and for its reader; and boundary marker for the total weight of the identification system.

7. A method according to claim 1, wherein in order to determine said binary values of the state variable concerning effective radio coverage of each device in the form of an electronic label by its reader, the automatic comparison incorporates in its determination a function of a Friis equation that evaluates the powers transmitted and received by each on-board RF device.

8. An aircraft on which on-board components are identified, each with the help of at least one RF device in the form of a label, wherein the technology and the position of at least some of said devices are derived from the modeling/simulation method according to claim 1.

9. An aircraft according to claim 8, wherein at least one device in the form of an electronic label is provided exclusively with a freely readable memory zone; a procedure for authenticating the RF device is followed by a procedure for deciphering payload data which procedures are performed remotely via a reader that is itself on board; the remote authentication procedure having recourse to an authentication digest in the form of a message authentication code obtained by hashing the payload data as a function of a secret authentication key; the remote deciphering procedure making use of a generated value and of a secret deciphering key of truncated length.
